(19) United States
(12) Patent Application Publication
(10) Pub. No.: US 2010/0318760 A1
(43) Pub. Date: Dec. 16, 2010

(54) MEMORY CONTROLLER, NONVOLATILE STORAGE DEVICE, AND NONVOLATILE STORAGE SYSTEM

(76) Inventors: Hirokazu So, Osaka (JP); Hiroshi Sakurai, Osaka (JP); Hirofumi Nakagaki, Osaka (JP); Masato Suto, Osaka (JP)

Correspondence Address: MARK D. SARALINO (PAN);RENNER, OTTO, BOISSELLE & SKLAR, LLP, 1621 EUCLID AVENUE, 19TH FLOOR, CLEVELAND, OH, 44115, US

(21) Appl. No.: 12/526,372

(22) PCT Filed: Jan. 28, 2009
(86) PCT No.: PCT/JP2009/000334

§ 371 Date: Aug. 7, 2009

(30) Foreign Application Priority Data
Jan. 30, 2008 (JP) 2008-018781

(51) Int. Cl. G06F 12/02; G06F 12/00

(52) U.S. Cl. 711/173; 711/E12.001; 711/E12.002

(57) ABSTRACT

A method for use in a nonvolatile storage device that can resize one or more partitions prevents an address management table from becoming complicated after repeated resizing of partitions. When a partition is resized, a logical-to-physical conversion table is updated by shifting a physical block address corresponding to a partition subsequent to the resized partition by the resized amount of the partition. The method enables both logical addresses corresponding to partitions and logical addresses not corresponding to partitions to be constantly continuous to one another.

### TECHNICAL FIELD

The present technology relates to a memory controller for controlling a nonvolatile memory, a nonvolatile storage device that includes a memory controller, and a nonvolatile storage system that includes a nonvolatile storage device and an access device.

### BACKGROUND ART

A variety of media are used to store digital data such as music content and video data. Examples include semiconductor storage media, magnetic disks, optical discs, and magneto-optical disks. Among them, semiconductor storage media are compact and lightweight, and have recently been developed rapidly toward a larger capacity, a higher speed, and a lower cost. Thus, semiconductor storage media can be used in many devices, such as digital still cameras, mobile telephones, portable music players, television sets, and DVD recorders. A Secure Digital (SD) memory card (trademark) is one typical example of semiconductor storage media. SD memory cards with an extremely large storage capacity of, for example, 8 gigabytes or 16 gigabytes are now commercially available. As nonvolatile storage devices increase their storage capacity, there tends to be an increasing number of circumstances in which a single nonvolatile storage device is shared by a plurality of applications.

To define data storage areas for each application, the storage area of the nonvolatile storage device, which is physically a single storage area, may be partitioned in the logical space, and storage areas that partition the logical space (hereafter referred to as “partitions”) may be allocated to each application. Patent Citation 1 discloses a method for generating, deleting, and resizing partitions while data has been stored in partitions defined in a nonvolatile storage device.

Patent Citation 1: Japanese Unexamined Patent Publication No. H5-81091

### DISCLOSURE OF INVENTION

### Technical Problem

With the above conventional technique, partition information, which indicates units of partitions, is managed using a first table and a second table; the first table stores information about currently occupied partitions and the second table stores unoccupied partition information remaining after the information about currently occupied partitions is excluded from the entire partition information. With the above conventional technique, the first table and the second table are updated every time when the processing for generating, deleting, or resizing a partition is performed.

After repeated generation, deletion and resizing of partitions, however, partitions stored in the first table and the second table may become fragmented in the logical space. Such fragmented partitions will complicate the process of converting a logical address in a currently in-use partition to a physical address (hereinafter, this process is referred as “logical-to-physical conversion process”). The complicated logical-to-physical conversion process can cause the processing speed for reading and writing, which are the main functions of a nonvolatile storage device, to be constantly low.

To solve the above problem, it is an object of the present technology to provide a memory controller, a nonvolatile storage device, and an access device that prevent partitions from becoming fragmented after repeated resizing of partitions.

### Technical Solution

To achieve the above object, the memory controller of the present technology is a memory controller that accesses a nonvolatile memory having a storage area whose logical address space is partitioned. The memory controller includes a partition management table storing a number and a size of a partition that partitions the logical address space, a logical-to-physical conversion table storing a correspondence between a logical address of the nonvolatile memory and a physical address of the nonvolatile memory, a storage area management unit that externally receives a command indicating to change a partition, and changes a size of the partition stored in the partition management table and changes a correspondence between a logical address and a physical address stored in the logical-to-physical conversion table in accordance with size change performed for the partition, and a memory interface that accesses the nonvolatile memory using a physical address that is obtained from the logical-to-physical conversion table by the storage area management unit.

When the command indicates to increase the size of the partition, the storage area management unit may update the partition management table by changing the size of the partition to a designated size, and update the logical-to-physical conversion table by changing an address of a physical block corresponding to a partition subsequent to the partition for which size change is performed in a manner to correspond to an address of a logical block greater by an amount of the size increase.

When the command indicates to decrease the size of the partition, the storage area management unit may update the partition management table by changing the size of the partition to a designated size, and update the logical-to-physical conversion table by changing an address of a physical block corresponding to a partition subsequent to the partition for which size change is performed in a manner to correspond to an address of a logical block smaller by an amount of the size decrease.

To achieve the above object, the nonvolatile storage device of the present technology is a nonvolatile storage device including a nonvolatile memory having a storage area whose logical address space is partitioned, and a memory controller that accesses the nonvolatile memory. The memory controller includes a partition management table storing a number and a size of a partition that partitions the logical address space, a logical-to-physical conversion table storing a correspondence between a logical address of the nonvolatile memory and a physical address of the nonvolatile memory, a storage area management unit that externally receives a command indicating to change a partition, and changes a size of the partition stored in the partition management table and changes a correspondence between a logical address and a physical address stored in the logical-to-physical conversion table in accordance with size change performed for the partition, and a memory interface that accesses the nonvolatile memory using a physical address that is obtained from the logical-to-physical conversion table by the storage area management unit.

When the command indicates to increase the size of the partition, the storage area management unit may update the partition management table by changing the size of the partition to a designated size, and update the logical-to-physical conversion table by changing an address of a physical block corresponding to a partition subsequent to the partition for which size change is performed in a manner to correspond to an address of a logical block greater by an amount of the size increase.

When the command indicates to decrease the size of the partition, the storage area management unit may update the partition management table by changing the size of the partition to a designated size, and update the logical-to-physical conversion table by changing an address of a physical block corresponding to a partition subsequent to the partition for which size change is performed in a manner to correspond to an address of a logical block smaller by an amount of the size decrease.

To achieve the above object, the nonvolatile storage system of the present technology is a nonvolatile storage system including a nonvolatile storage device and an access device that accesses the nonvolatile storage device. The nonvolatile storage device includes a nonvolatile memory and a memory controller that accesses the nonvolatile memory. The memory controller includes a partition management table storing a number and a size of a partition that partitions the logical address space, a logical-to-physical conversion table storing a correspondence between a logical address of the nonvolatile memory and a physical address of the nonvolatile memory, a storage area management unit that externally receives a command indicating to change a partition, and changes a size of the partition stored in the partition management table and changes a correspondence between a logical address and a physical address stored in the logical-to-physical conversion table in accordance with size change performed for the partition, and a memory interface that accesses the nonvolatile memory using a physical address that is obtained from the logical-to-physical conversion table by the storage area management unit.

When the command indicates to increase the size of the partition, the storage area management unit may update the partition management table by changing the size of the partition to a designated size, and update the logical-to-physical conversion table by changing an address of a physical block corresponding to a partition subsequent to the partition for which size change is performed in a manner to correspond to an address of a logical block greater by an amount of the size increase.

When the command indicates to decrease the size of the partition, the storage area management unit may update the partition management table by changing the size of the partition to a designated size, and update the logical-to-physical conversion table by changing an address of a physical block corresponding to a partition subsequent to the partition for which size change is performed in a manner to correspond to an address of a logical block smaller by an amount of the size decrease.

### ADVANTAGEOUS EFFECTS

According to the present technology, the logical-to-physical conversion table is updated every time when one or more partitions are resized. This prevents partitions in the logical-to-physical conversion table from becoming fragmented. Without complicating the logical-to-physical conversion process, the present technology prevents the processing speed for reading and writing from being lowered after repeated resizing of partitions.

The present technology provides a memory controller, a nonvolatile storage device, and an access device that do not cause the processing speed for reading and writing to be lowered after repeated resizing of partitions.

### BRIEF DESCRIPTION OF DRAWINGS

FIG. 1 is a block diagram showing the structure of a nonvolatile storage system according to an embodiment of the present technology.

FIG. 2 shows the structure of a physical block of a nonvolatile memory 120 in the embodiment of the present technology.

FIG. 3 shows examples of the structures of a logical-to-physical conversion table 112, a physical block management table 113, and a partition management table 114 in the embodiment of the present technology.

FIG. 4 is a flowchart of the operation of a nonvolatile storage device that is performed after the nonvolatile storage device receives an initializing command.

FIG. 5 shows the initial states of the logical-to-physical conversion table 112, the physical block management table 113, and the partition management table 114.

FIG. 6 shows the states of the tables 112, 113, and 114 when the size of the partition PT0 is set.

FIG. 7 shows the states of the tables 112, 113, and 114 when the size of the partitions PT1, PT2, and PT3 is set.

FIG. 8 is a flowchart of the operation of the nonvolatile storage device that is performed after the nonvolatile storage device receives a write command.

FIG. 9 shows the states of the tables 112, 113, and 114 after data is written to the partition PT0.

FIG. 10 shows the states of the tables 112, 113, and 114 after data is written to the partition PT1.

FIG. 11 shows the states of the tables 112, 113, and 114 after data is written to all partitions.

FIG. 12 is a flowchart of the operation of the nonvolatile storage device that is performed after the nonvolatile storage device receives a partition resizing command.

FIG. 13 shows the states of the tables 112, 113, and 114 after the size of the partition PT2 is changed.

FIG. 14 is a flowchart of the operation of the nonvolatile storage device that is performed after the nonvolatile storage device receives a partition resizing command.

FIG. 15 shows the states of the tables 112, 113, and 114 after the size of the partition PT1 is changed.

FIG. 16 shows the states of the tables 112, 113, and 114 after the size of the partition PT0 is changed.

FIG. 17 is a flowchart of the operation of the nonvolatile storage device that is performed after the nonvolatile storage device receives a partition generation command.

FIG. 18 shows the states of the tables 112, 113, and 114 after the size of the partition PT2 is changed.

FIG. 19 is a flowchart of the operation of the nonvolatile storage device that is performed after the nonvolatile storage device receives a read command.

### EXPLANATION OF REFERENCE

100 nonvolatile storage device
110 memory controller
111 access interface
112 logical-to-physical conversion table
113 unoccupied physical block management table
114 partition management table
115 storage area management unit
116 memory interface
120 nonvolatile memory
121 system data storage area
122 data storage area
200 access device

### BEST MODE FOR CARRYING OUT THE INVENTION

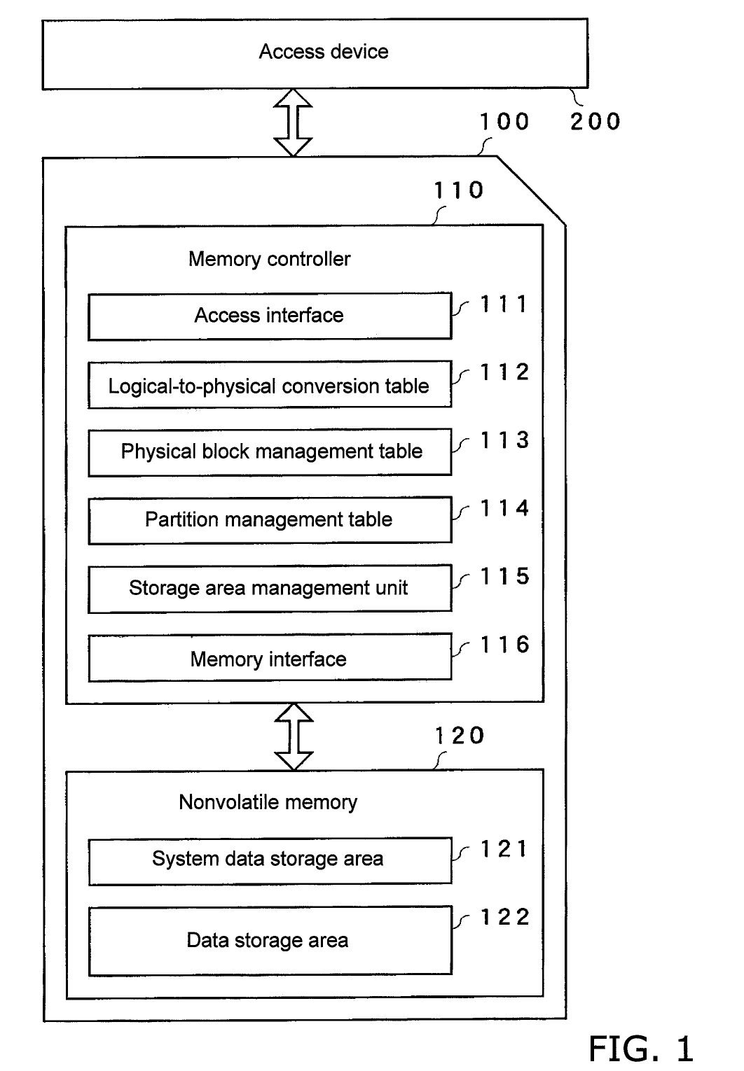

An embodiment of the present technology will now be described with reference to the drawings attached. FIG. 1 shows an example of the structure of a nonvolatile storage system according to the embodiment of the present technology. The nonvolatile storage system shown in FIG. 1 includes a nonvolatile storage device 100 and an access device 200.

The nonvolatile storage device 100 includes a memory controller 110 and a nonvolatile memory 120.

The memory controller 110 includes an access interface 111, a logical-to-physical conversion table 112, a physical block management table 113, a partition management table 114, a storage area management unit 115, and a memory interface 116.

The access interface 111 allows commands and data to be transmitted to and received from the access device 200.

The logical-to-physical conversion table 112 stores physical block addresses corresponding to logical block addresses. Logical blocks are formed by partitioning the logical address space in units of 256 kilobytes.

The physical block management table 113 stores the usage status of each physical block of the nonvolatile memory 120.

The partition management table 114 stores the number and the size of partitions that are defined in the nonvolatile memory 120.

The storage area management unit 115 manages and updates the logical-to-physical conversion table 112, the physical block management table 113, and the partition management table 114, and determines a physical block to which data is to be written or from which data is to be read using the tables 112, 113, and 114.

The memory interface 116 controls data to be read from and written to the nonvolatile memory 120.

The nonvolatile memory 120 is formed by a flash memory, and includes a system data storage area 121 and a data storage area 122. The system data storage area 121 stores system data, which is used to manage the nonvolatile memory 120. The system data includes

(1) data indicating the positions and the number of defective blocks in the nonvolatile memory 120,

(2) address management data that will be used to reconfigure the tables 112, 113, and 114 formed using a volatile memory (RAM for example) after the nonvolatile storage device 100 is powered on, and

(3) error correction code data that is used to correct errors of data stored in the nonvolatile memory 120.

The data storage area 122 stores content data including music data and video data, which is accessed by the access device 200, and file system data. The data storage area 122 stores the file system data when the content data is managed using a file system, such as a FAT file system.

The access device 200 transmits a command to the nonvolatile storage device 100 to write and read data to and from the nonvolatile storage device 100. The command includes a partition number identifying a partition and a relative logical address (RLA) indicating the position of a logical block included in the partition.

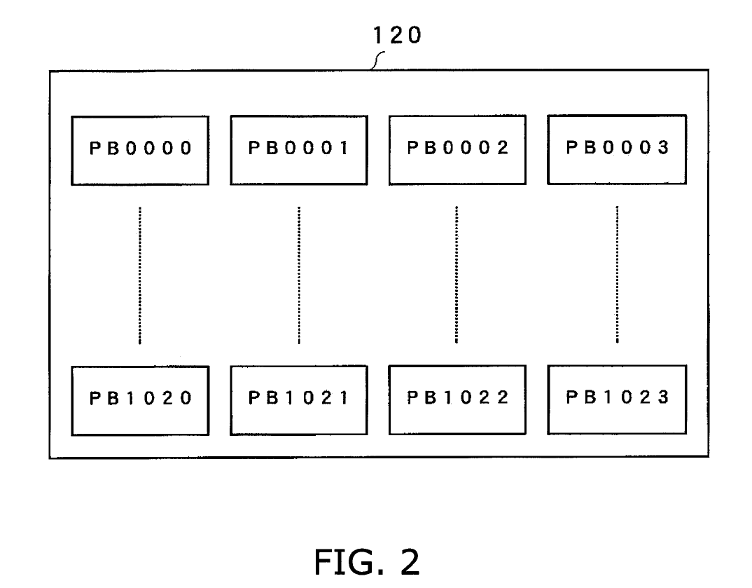

FIG. 2 schematically shows the nonvolatile memory 120. The nonvolatile memory 120 includes a plurality of physical blocks, which are units by which data can be erased. The size and the number of the physical blocks included in the nonvolatile memory 120 may vary depending on the type of the flash memory forming the nonvolatile memory 120. In the present embodiment, the nonvolatile memory 120 includes, for example, 1024 physical blocks PB0000 to PB1023, each of which stores 256 kilobytes of data.

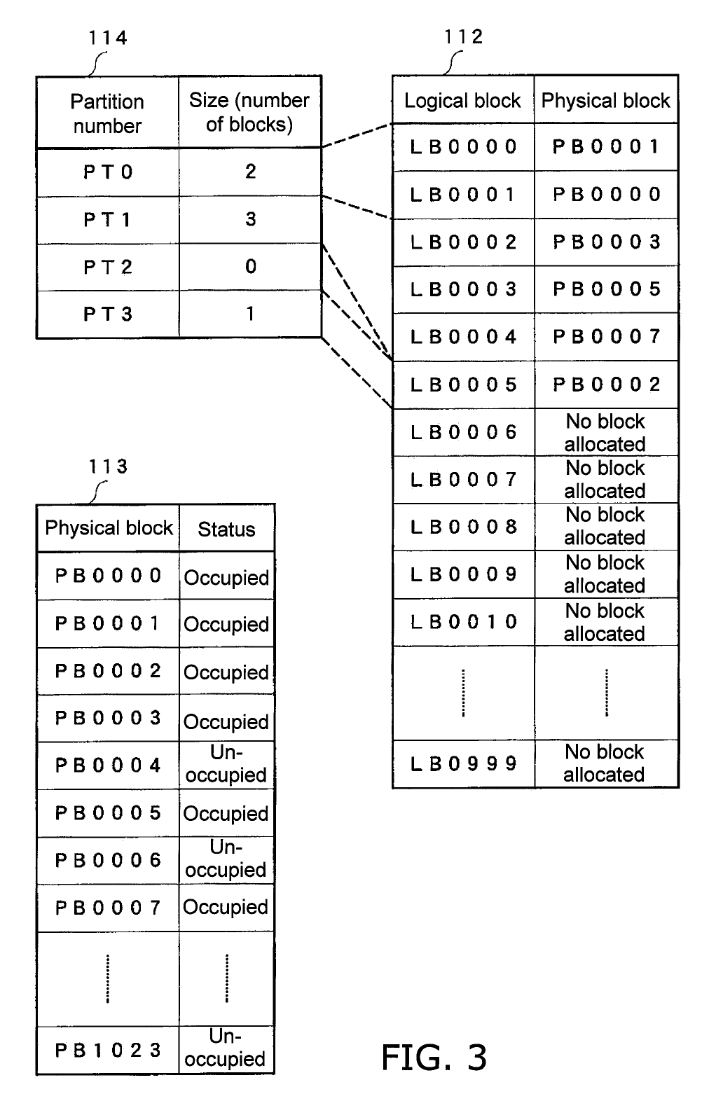

The structures of the logical-to-physical conversion table 112, the physical block management table 113, and the partition management table 114 will now be described with reference to FIG. 3. FIG. 3 schematically shows the correspondence relationship among the tables 112, 113, and 114.

The logical-to-physical conversion table 112 stores 1000 logical block addresses LB0000 to LB0999. Although the nonvolatile memory 120 includes 1024 physical blocks, logical block addresses less than 1024 are stored in the logical-to-physical conversion table 112, considering that the physical blocks of the nonvolatile memory 120 include defective blocks to which data cannot be written.

The logical-to-physical conversion table 112 stores physical block addresses corresponding in one-to-one to the logical blocks LB0000 to LB0005. In this example, the physical block PB0001 corresponds to the logical block LB0000, and the physical block PB0000 corresponds to the logical block LB0001. The logical blocks LB0006 to LB0999 have no corresponding physical blocks, and have a value indicating that no physical block has been allocated. In one example, the value indicating that no physical block has been allocated is an address of a physical block that is not in existence, such as PB1024.

The physical block management table 113 stores information indicating whether each physical block of the nonvolatile memory 120 is in an unoccupied status, in which the physical block stores no valid data, or in an occupied status, in which the physical block stores valid data. In the logical-to-physical conversion table 112, for example, the physical blocks PB0000 to PB0003, PB0005, and PB0007 are in an occupied status, and the other physical blocks are in an unoccupied status.

The partition management table 114 stores a partition number PTn (n=an integer from 0 to 3) as an identifier of each partition, and the number of logical blocks included in the partition identified with each partition number. The table 114 stores four partitions PT0 to PT3, and stores the number of logical blocks included in each partition, that is, 2 for the partition PT0, 3 for the partition PT1, 0 for the partition PT2, and 1 for the partition PT3.

The storage area management unit 115 uses the tables 112 and 114 to detect a logical block designated by the access device 200.

A method for obtaining the correspondence between a logical block stored in the table 112 and a partition stored in the table 114 will now be described with reference to FIG. 3.

In one example, the access device 200 transmits a data read or write command designating the partition PT1 and a relative logical address of 0. In the present embodiment, the value of a relative logical address is an integer greater than or equal to 0. The value of a relative logical address indicates what number a designated logical block is, assuming that the first logical block of the partition is the 0-th logical block. In this example, the access device 200 designates the first logical block of the partition PT1. The access device 200 cannot designate a partition with a size of 0 when reading or writing data.

The storage area management unit 115 detects, from the partition management table 114, the size of all partitions having partition numbers smaller than the partition number of the designated partition PT1. In this example, the storage area management unit 115 detects only the size of the partition PT0, that is, a size of 2. The storage area management unit 115 adds the relative logical address of 0 to the size of 2 to obtain a numerical value of 2. Based on the obtained numerical value of 2, the storage area management unit 115 detects the logical block LB0002, which is the second logical block counted from the 0-th logical block LB0000 stored in the table 112. In this manner, the storage area management unit 115 identifies the logical block LB0002 as a logical block designated by the access device 200 using the partition PT1 and the relative logical address of 0. Also, the storage area management unit 115 identifies the logical block LB0002 as the first logical block of the partition PT1.

Subsequently, the access device 200 transmits a read or write command designating the partition PT1 and a relative logical address of 2. The storage area management unit 115 performs the same processing as described above, and obtains a numerical value of 4 and detects the logical block LB0004, which is the fourth logical block counted from the 0-th logical block LB0000 stored in the table 112. The logical block LB0004 is a logical block designated by the access device 200 using the partition PT1 and the relative logical address of 2. In this example, the upper bound of a relative logical address that can be designated using the partition PT1 is 2, which is smaller than the size of the partition PT1 by 1. The storage area management unit 115 determines that the logical block designated by the access device 200 using the partition PT1 and the relative logical address of 2 is the last logical block of the partition PT1, and identifies the logical block LB0004 as the last logical block of the partition PT1.

As described above, the storage area management unit 115 uses the partition management table 114 to determine that the logical blocks LB0002 to LB0004 correspond to the partition PT1. In the same manner, the logical blocks LB0000 and LB0001 correspond to the partition PT0, and the logical block LB0005 corresponds to the partition PT3.

In the present embodiment, as described above, logical blocks from which data is to be read or to which data is to be written are detected using a partition number and a relative logical address every time when data is read or written.

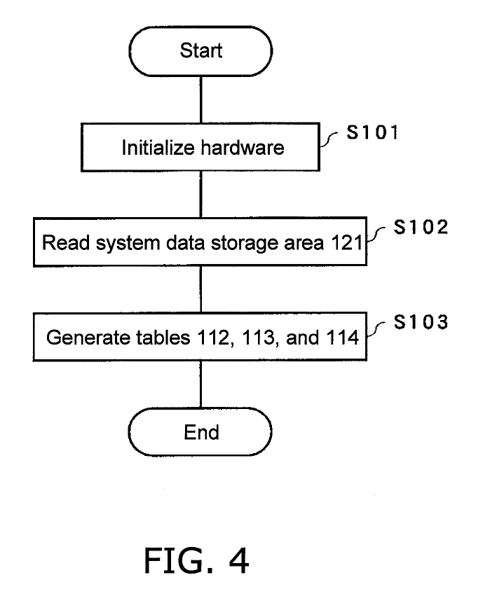

One example of the operation of the nonvolatile storage system according to the present embodiment will now be described with reference to FIGS. 4 to 18. A process for initializing the nonvolatile storage device 100 will be described first. The access device 200 transmits an initializing command when the nonvolatile storage device 100 is powered on or when the nonvolatile storage device 100 is mounted. FIG. 4 is a flowchart of the operation of the nonvolatile storage device 100 that is performed when the access device 200 transmits an initializing command to the nonvolatile storage device 100.

When the nonvolatile storage device 100 receives an initializing command, the storage area management unit 115 initializes hardware by, for example, clearing its internal memory including the tables 112, 113, and 114 and checking the connection status of the nonvolatile memory 120 (S101). Subsequently, the storage area management unit 115 obtains information stored in the system data storage area 121 of the nonvolatile memory 120, such as address management information (S102). The storage area management unit 115 then generates the tables 112, 113, and 114 in the internal memory based on the obtained address management information, and ends the initializing process (S103).

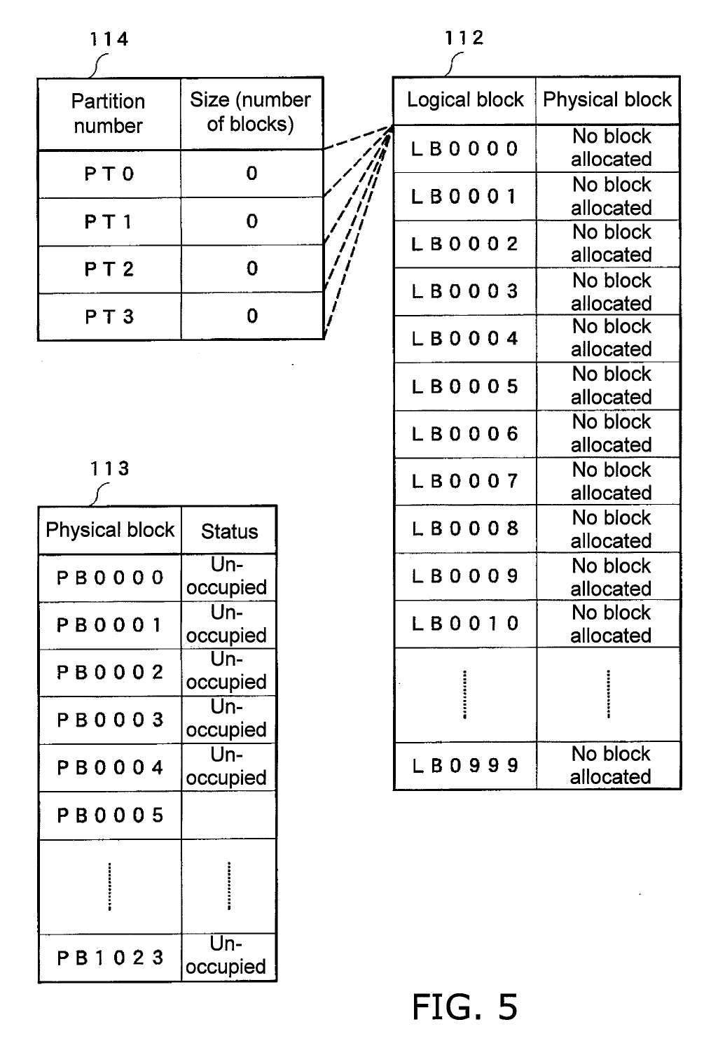

FIG. 5 shows the tables 112, 113, and 114 in which the size of all partitions is 0. FIG. 5 shows the initial states of the tables 112, 113, and 114, which are generated through the initializing process.

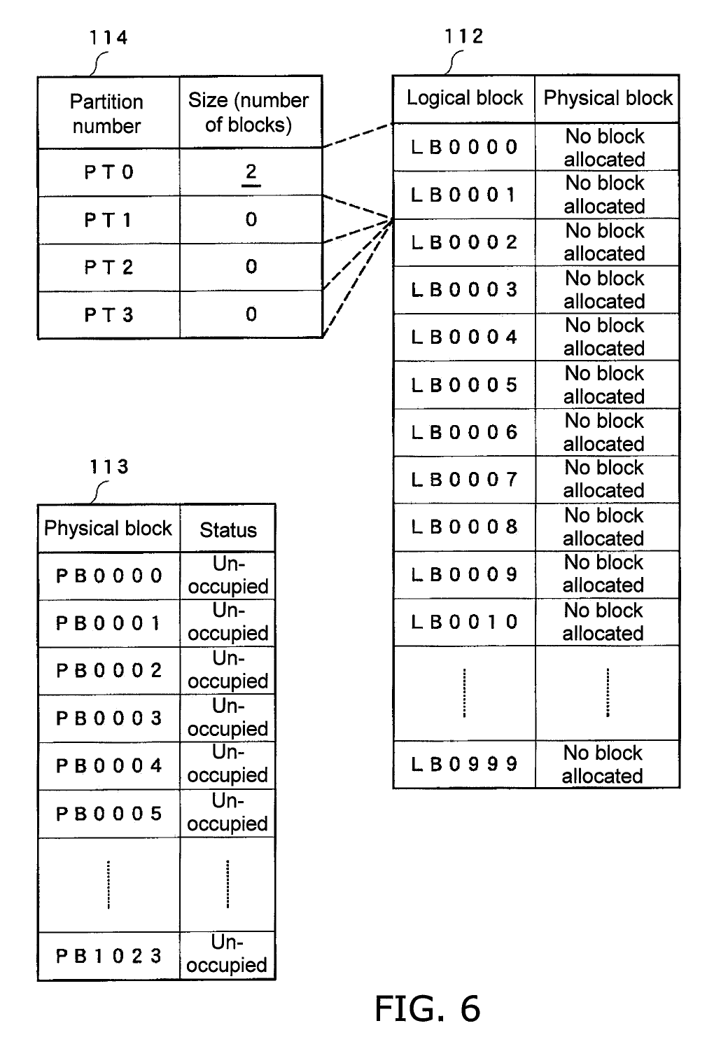

The access device 200 first changes the size of the partitions to values greater than 0. The access device 200 transmits a partition resizing command indicating to change the size of the partition PT0 to 2 to the nonvolatile storage device 100. When the nonvolatile storage device 100 receives the resizing command, the storage area management unit 115 updates the partition management table 114 by changing the size of the partition PT0 to 2. FIG. 6 shows the state of the updated partition management table 114. The underlined portion of the table 114 in FIG. 6 indicates the updated portion. The underlined portions of the tables 112, 113, and 114 in figures other than FIG. 6 also indicate updated portions.

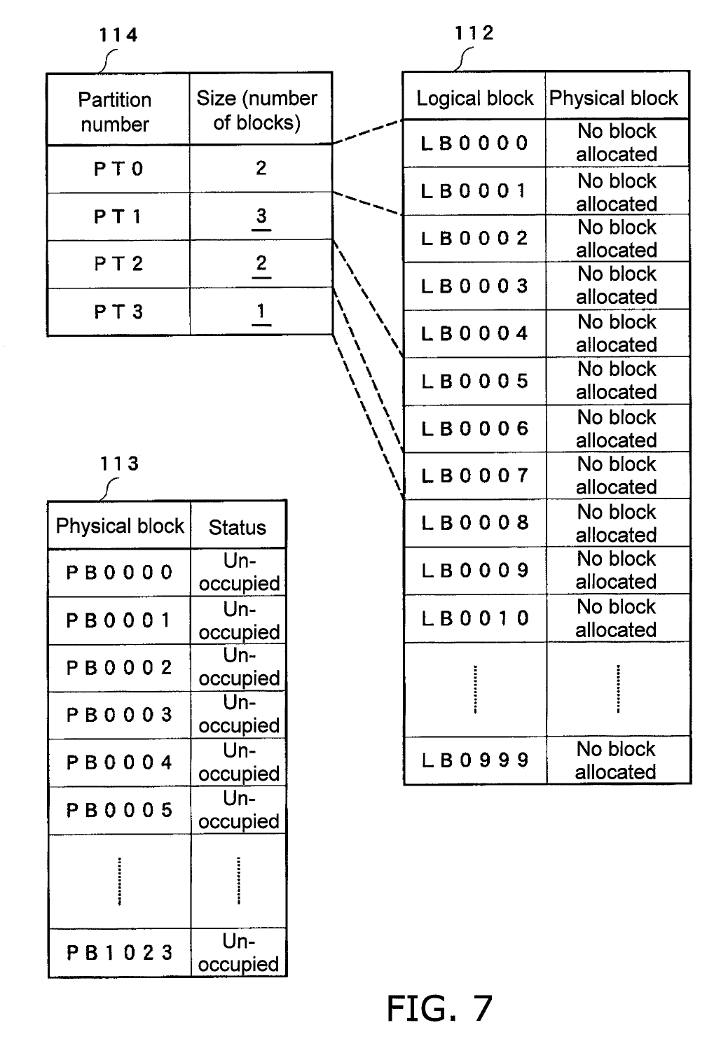

Subsequently, the nonvolatile storage device 100 receives a resizing command indicating to change the size of the partition PT1 to 3 from the access device 200, and further receives a resizing command indicating to change the size of the partition PT2 to 2 and then a resizing command indicating to change the size of the partition PT3 to 1. After receiving these commands, the storage area management unit 115 updates the partition management table 114 to the state shown in FIG. 7.

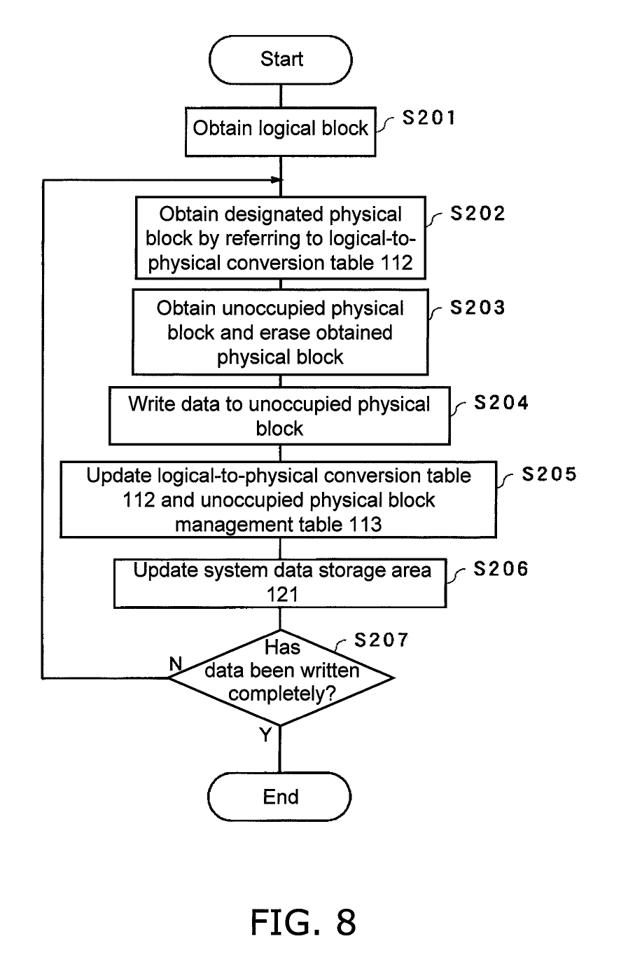

A process for writing data will now be described with reference to a flowchart of FIG. 8. The access device 200 transmits a read or write command designating a relative logical address RLA of the partition PT0, which is a relative logical address of 0, to the nonvolatile storage device 100, and then the storage device management unit 115 obtains the logical block LB0000 based on the designated partition number and the designated relative logical address RLA (S201).

The storage area management unit 115 then obtains a physical block corresponding to the logical block LB0000 by referring to the logical-to-physical conversion table 112 (S202). In the logical-to-physical conversion table 112 shown in FIG. 7, the logical block LB0000 has no corresponding physical block.

The nonvolatile storage device 100 randomly obtains an unoccupied physical block, for example, the physical block PB0001, and erases the obtained physical block PB0001 (S203). Subsequently, the nonvolatile storage device 100 writes data transmitted from the access device to the erased physical block PB0001 (S204). When the size of the data received from the access device 200 is smaller than 256 kilobytes, which is the size of the physical block PB0001, the nonvolatile storage device 100 generates a copy of the data stored in the physical block detected in step S202.

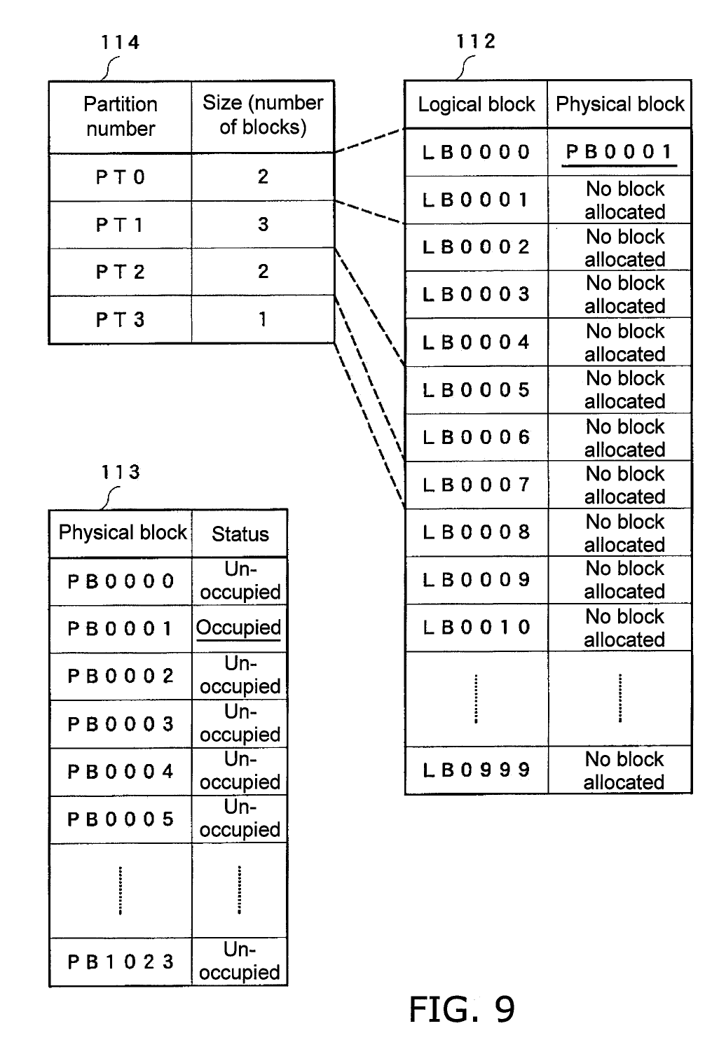

The storage area management unit 115 updates the logical-to-physical conversion table 112 in a manner that the physical block PB0001 corresponds to the logical block LB0000 (S205). FIG. 9 shows the state of the updated logical-to-physical conversion table 112. The storage area management unit 115 further updates the physical block management table 113 to the state shown in FIG. 9 by changing the status of the physical block PB0001 to an occupied status (S205).

The storage area management unit 115 updates information stored in the system data storage area 121, such as address management information, based on the updates of the tables 112 and 113 performed in step S205 (S206). This enables the changes performed in step S205 to remain effective after the nonvolatile storage device 100 is powered on again.

Subsequently, the storage area management unit 115 determines whether all write data received from the access device 200 has been written completely (S207). When determining that the data has been written completely, the storage area management unit 115 ends the data writing process. When determining that the data has yet to be written completely, the storage area management unit 115 returns to step S202, and writes data to the next logical block, which is subsequent to the logical block to which data has been written.

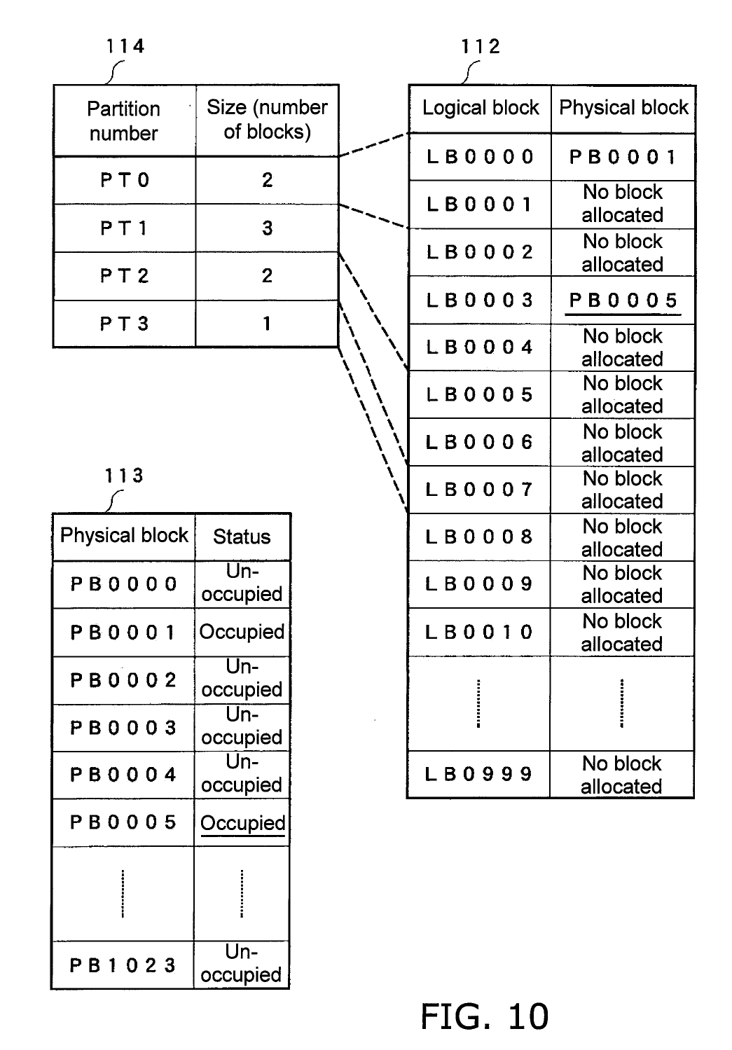

When the access device 200 designates the relative logical address RLA of the partition PT1, which is a relative logical address of 1, in the next data writing process, the storage area management unit 115 performs the same processing as described above and obtains the logical block LB0003 as a block to which data is to be written. The logical block LB0003 has no corresponding physical block in this example as well. Thus, the nonvolatile storage device 100 obtains, for example, the physical block PB0005, and writes data transmitted from the access device to the physical block PB0005, and then updates the tables 112 and 113. FIG. 10 shows the states of the updated tables 112 and 113.

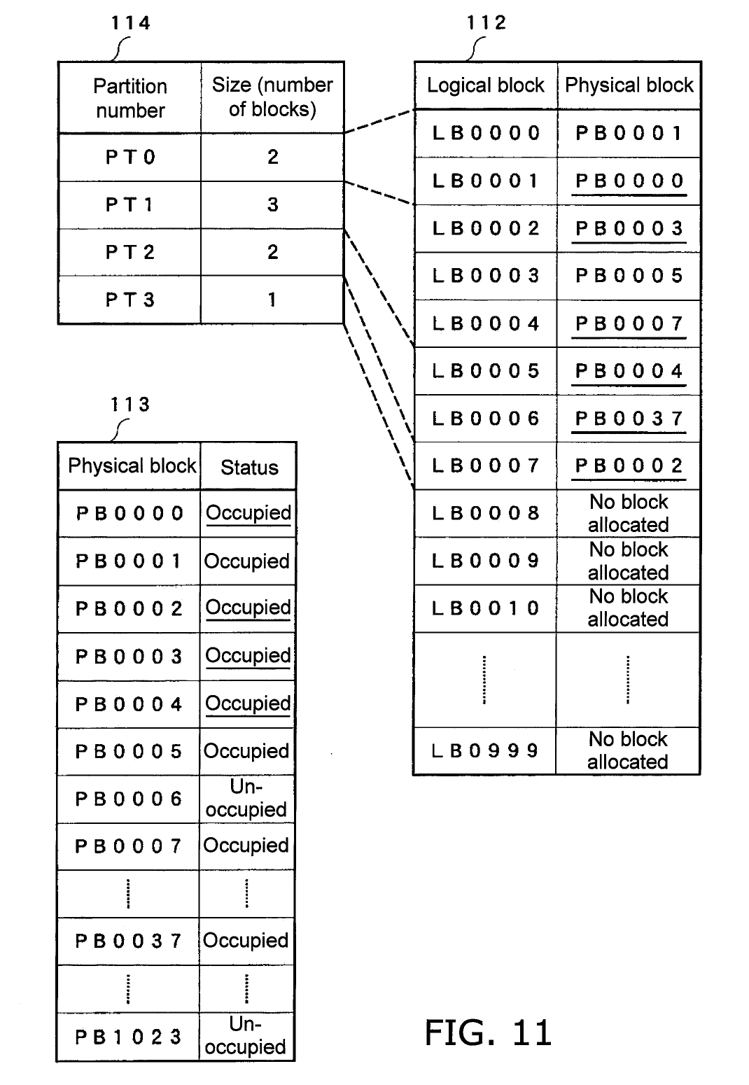

The access device 200 continues the data writing process. As a result, the tables 112, 113, and 114 are updated to the states shown in FIG. 11. In FIG. 11, all logical blocks included in each partition have corresponding physical blocks.

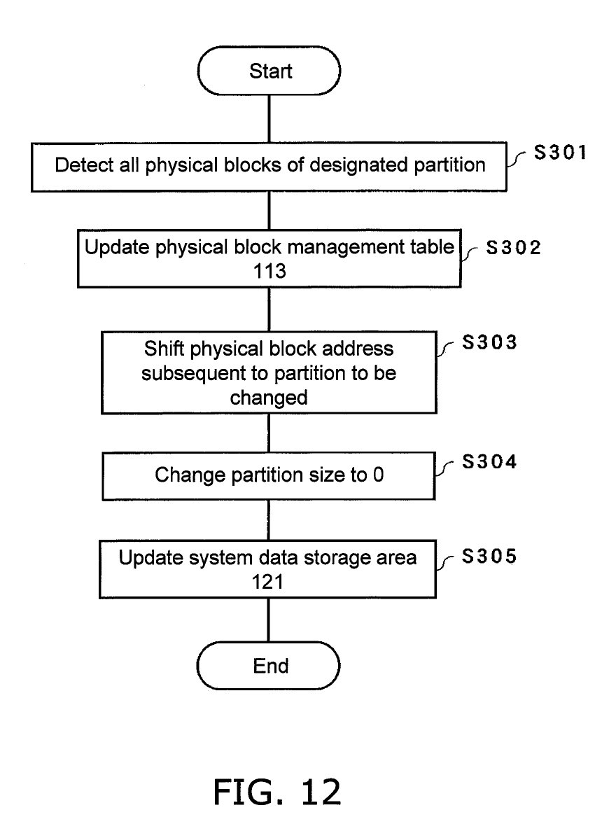

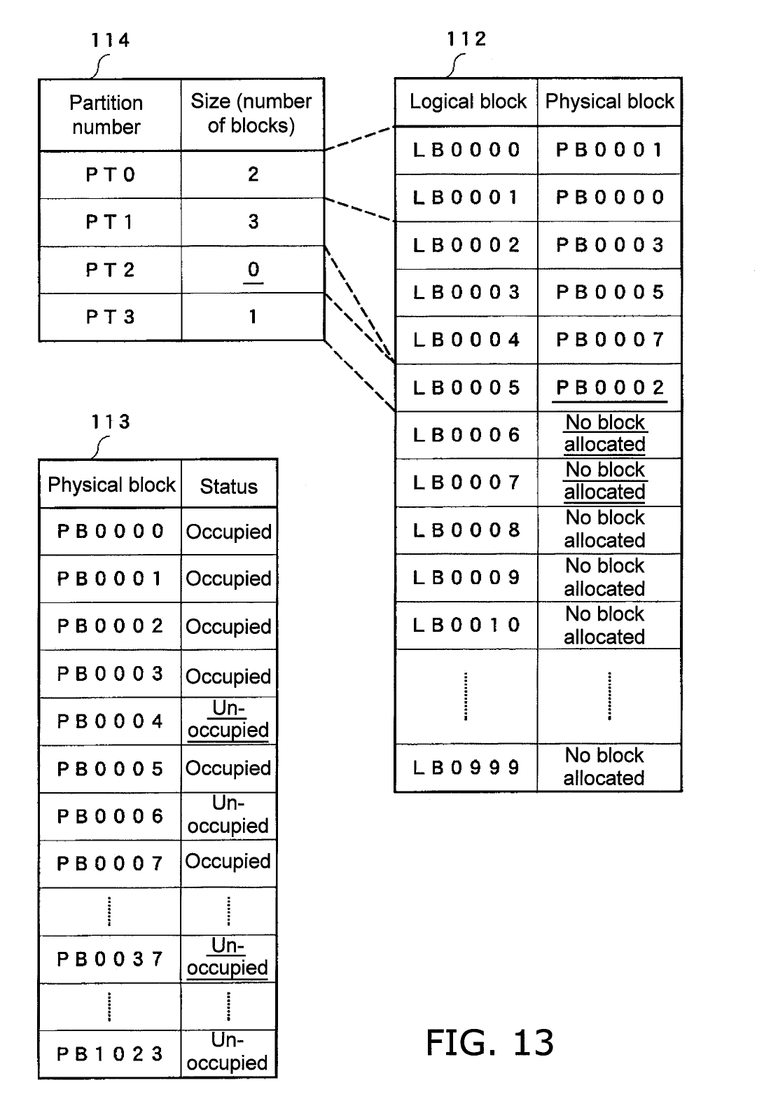

FIG. 12 is a flowchart of the operation of the nonvolatile storage device 100 that is performed when the size of a partition is changed to 0. In one example, the access device 200 transmits a resizing command indicating to change the size of the partition PT2 to 0. The operation performed in this example will now be described with reference to FIGS. 12 and 13. When the nonvolatile storage device 100 receives a resizing command, the storage area management unit 115 detects the physical blocks PB0004 and PB0037 corresponding to the logical blocks of the partition PT2 by referring to the tables 112 and 114 (S301). The storage area management unit 115 updates the physical block management table 113 by changing the status of the physical blocks PB0004 and PB0037 to an unoccupied status (S302). FIG. 13 shows the state of the updated physical block management table 113.

The storage area management unit 115 shifts a physical block address corresponding to a partition subsequent to the partition PT2 in the logical-to-physical conversion table 112. In this example, the storage area management unit 115 shifts the physical block address PB0002 corresponding to the logical block address LB0007 of the partition PT3 in a manner to correspond to a logical block whose address is smaller than the logical block address LB0007 by two logical blocks, that is, by the size of the partition PT2 (S303). This changes the physical block address corresponding to the logical block address LB0005 in the logical-to-physical conversion table 112 from PB0004 to PB0002. In this state, the physical block address PB0037 still corresponds to the logical block address LB0006. The storage area management unit 115 changes the physical block address corresponding to the logical block address LB0006 to a value indicating that no block has been allocated. The storage area management unit 115 also changes the physical block address corresponding to the logical block address LB0007 to a value indicating that no block has been allocated. FIG. 13 shows the state of the updated logical-to-physical conversion table 112.

The storage area management unit 115 further updates the partition management table 114 by changing the size of the partition PT2 to 0 (S304). FIG. 13 shows the state of the updated partition management table 114.

Subsequently, the storage area management unit 115 updates information stored in the system data storage area 121, such as address management information (S305). This enables the changes performed in steps S301 to S304 to remain effective after the nonvolatile storage device 100 is powered on again.

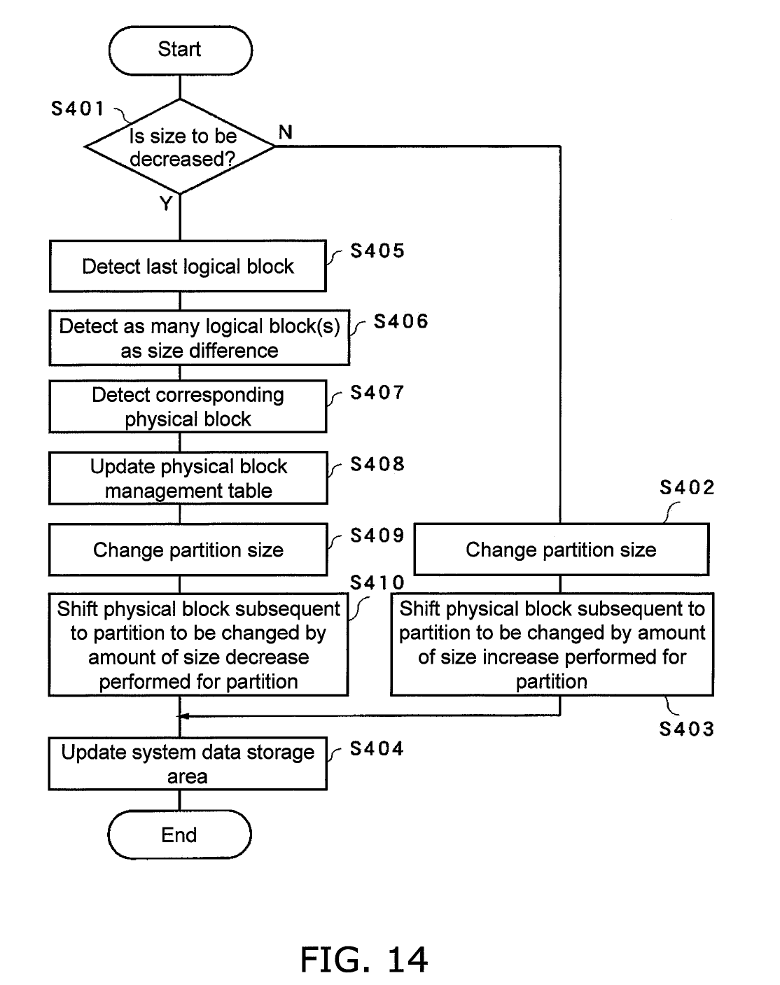

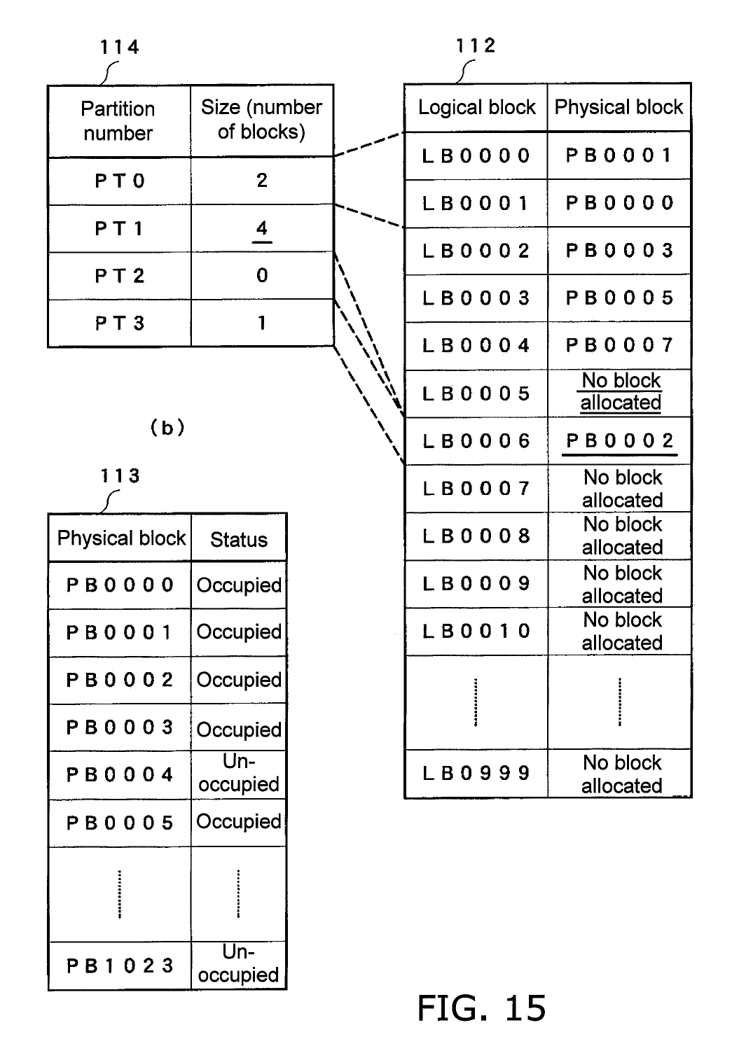

FIG. 14 is a flowchart of the operation of the nonvolatile storage device 100 that is performed when the nonvolatile storage device 100 receives a resizing command from the access device 200. In one example, the access device 200 transmits a resizing command indicating to change the size of the partition PT1 from 3 to 4. The operation performed in this example will now be described with reference to FIGS. 14 and 15. When the nonvolatile storage device 100 receives a resizing command, the storage area management unit 115 obtains a partition size of 3 as the size of the partition PT1 before resizing, and compares the partition size before resizing (hereafter referred to as the “original value”) with a designated size of 4, which is the size of the partition PT1 after resizing (hereafter referred to as the “resizing target value”). The storage area management unit 115 compares the original value and the resizing target value and determines whether the resizing is to decrease the partition size (S401). In this example, the original value is greater than the resizing target value. Thus, the storage area management unit 115 determines that the resizing is to increase the size of the partition PT1.

The storage area management unit 115 updates the partition management table 114 by changing the size of the partition PT1 to the resizing target value of 4 (S402). FIG. 15 shows the state of the updated partition management table 114.

The storage area management unit 115 shifts a physical block address corresponding to a partition subsequent to the partition PT1 in the logical-to-physical conversion table 112. In this example, the storage area management unit 115 shifts the physical block address PB0002 corresponding to the logical block address LB0005 of the partition PT3 in a manner to correspond to a logical block whose address is greater than the logical block address LB0005 by a single logical block, that is, by is an amount of the size increase performed for the partition PT1 (S403). As a result, the physical block address PB0002 corresponds to the logical block address LB0006 in the logical-to-physical conversion table 112. In this state, the address PB0002 still corresponds to the address LB0005 as well. The storage area management unit 115 updates the physical block address corresponding to the address LB0005 to a value indicating that no block has been allocated. FIG. 15 shows the state of the updated logical-to-physical conversion table 112.

Subsequently, the storage area management unit 115 updates information stored in the system data storage area 121, such as address management information (S404). This enables the changes performed in steps S402 to S404 to remain effective after the nonvolatile storage device 100 is powered on again.

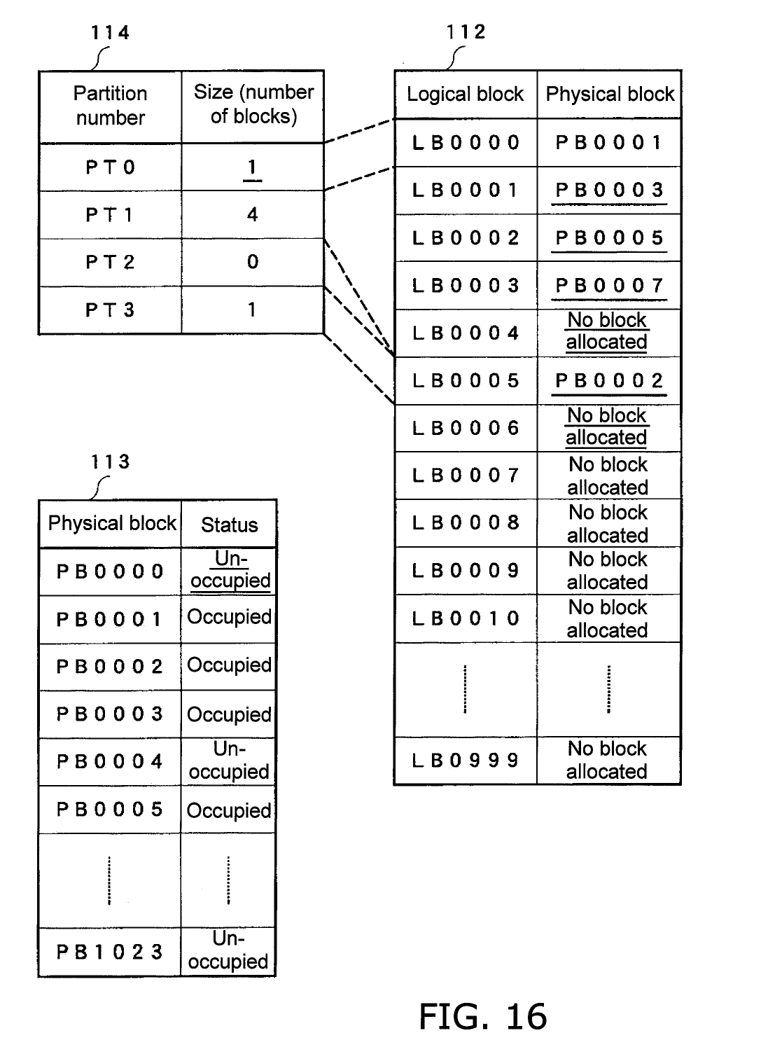

In one example, the access device 200 subsequently transmits a resizing command indicating to change the size of the partition PT0 from 2 to 1. The operation performed in this example will now be described with reference to FIGS. 14 and 16. When the nonvolatile storage device 100 receives a resizing command, the storage area management unit 115 detects the logical block LB0001, which is the last logical block among the logical blocks corresponding to the partition PT2 (S405).

The storage area management unit 115 then detects, in the direction from the detected logical block address LB0001 to the first logical block, a logical block address of a single logical block, which is as many as a difference between the original value and the resizing target value, using the logical-to-physical conversion table 112 (S406). In this example, the storage area management unit 115 detects only the address LB0001.

The storage area management unit 115 further detects the physical block PB0000 corresponding to the detected logical block LB0001 using the logical-to-physical conversion table 112 (S407). The storage area management unit 115 then updates the detected physical block PB0000 to a value indicating an unoccupied status (S408).

The storage area management unit 115 updates the partition management table 114 by changing the size of the partition PT0 to the resizing target value of 1 (S409). FIG. 16 shows the state of the updated partition management table 114.

The storage area management unit 115 shifts a physical block address corresponding to a partition subsequent to the partition PT0 in the logical-to-physical conversion table 112. In this example, the storage area management unit 115 shifts physical block addresses and information indicating that no block has been allocated corresponding to the logical block addresses LB0002 to LB0005 of the partition PT1 and a physical block address corresponding to the logical block address LB0006 of the partition PT3 in a manner to correspond to logical block addresses smaller than the logical block addresses LB0002 to LB0005 and LB0006 by a single logical block, that is, by an amount of the size decrease performed for the partition PT0 (S410). The storage area management unit 115 further updates the physical block address corresponding to the address LB0006 to a value indicating that no block has been allocated. FIG. 16 shows the state of the updated logical-to-physical conversion table 112.

Subsequently, the storage area management unit 115 updates information stored in the system data storage area 121, such as address management information (S404). This enables the changes performed in steps S405 to S410 to remain effective after the nonvolatile storage device 100 is powered on again.

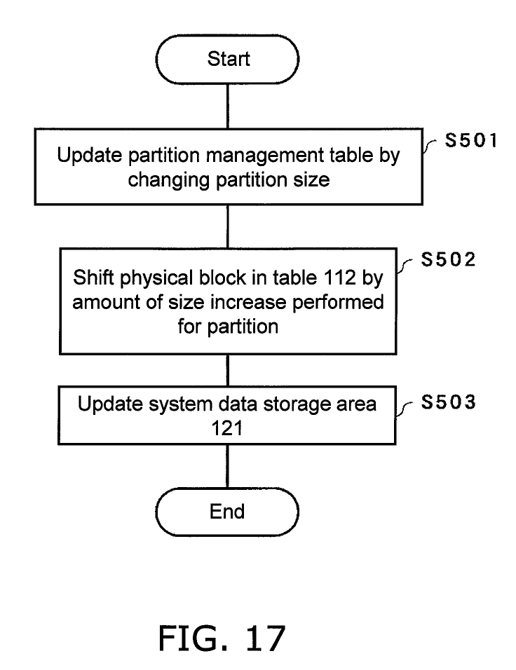

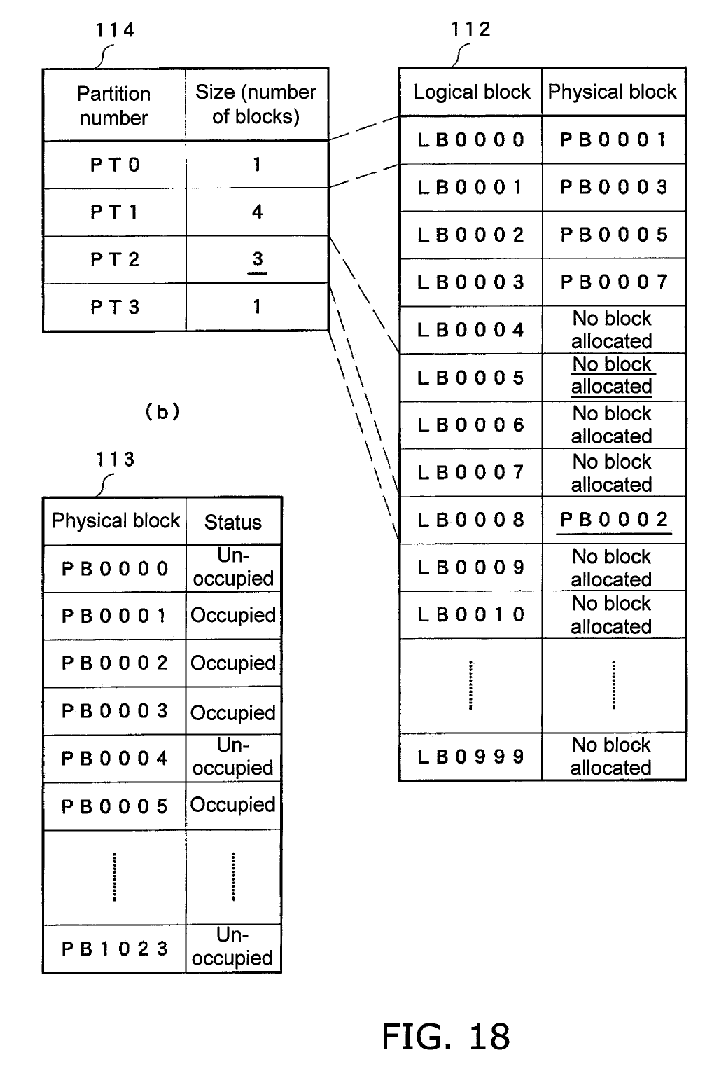

In one example, the access device 200 transmits a resizing command indicating to change the size of the partition PT2 from 0 to 3. The operation performed in this example will now be described with reference to FIGS. 17 and 18. When the nonvolatile storage device 100 receives a resizing command, the storage area management unit 115 updates the partition management table 114 by changing the size of the partition PT2 to 3 (S501).

The storage area management unit 115 shifts a physical block address corresponding to a partition subsequent to the partition PT2 in the logical-to-physical conversion table 112. In this example, the storage area management unit 115 shifts the physical block address PB0002 corresponding to the logical block address LB0005 of the partition PT3 in a manner to correspond to a logical block whose address is greater than the logical block address LB0005 by three logical blocks, that is, by an amount of the size increase performed for the partition PT2 (S502). As a result, the logical block address LB0008 corresponds to the physical block address PB0002 in the logical-to-physical conversion table 112. In this state, the address PB0002 still corresponds to the address LB0005 as well. The storage area management unit 115 updates the physical block address corresponding to the address LB0005 to a value indicating that no block has been allocated. FIG. 18 shows the state of the updated logical-to-physical conversion table 112.

Subsequently, the storage area management unit 115 updates information stored in the system data storage area 121, such as address management information (S503). This enables the changes performed in steps S501 and S502 to remain effective after the nonvolatile storage device 100 is powered on again.

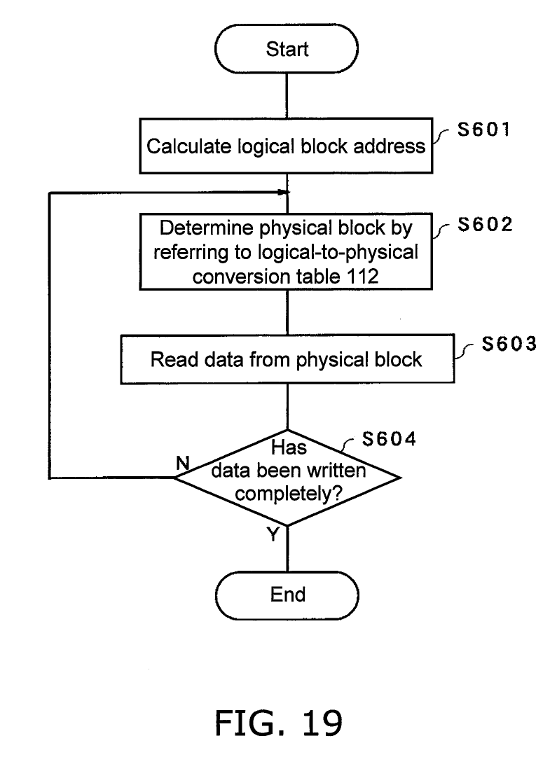

A process for reading data from the nonvolatile storage device 100 that is performed by the access device 200 will now be described with reference to FIG. 19. In the data reading process, the storage area management unit 115 detects a logical address of an access target using a partition number and a relative logical address, which are received from the access device 200 (S601). The storage area management unit 115 further detects a physical block corresponding to the detected logical block using the logical-to-physical conversion table 112 (S602). The access device 200 then accesses the detected physical block and reads data from the physical block (S603).

The storage area management unit 115 determines whether all data designated by the access device 200 has been read completely (S604). When determining that the data has been read completely, the storage area management unit 115 ends the data reading process. When determining that the data has yet to be read completely, the storage area management unit 115 returns to step S602, and reads data from the next logical block, which is subsequent to the logical block from which data has been read.

In the present embodiment, the logical-to-physical conversion table 112 is updated with the method described above every time when the processing for resizing a partition is performed. This prevents logical blocks corresponding to partitions in the logical-to-physical conversion table 112 from becoming fragmented. The present technology is particularly effective when applied to a semiconductor storage medium formed by a flash memory, which has been developed to have a larger capacity.

Although the present technology has been described based on the above embodiment, the present technology should not be limited to the above embodiment. The method and means described in the above embodiment may be modified without departing from the scope of the present technology. For example, the present technology includes the following modifications.

(1) Although the above embodiment describes the case in which the nonvolatile memory 120 is formed by a flash memory, the nonvolatile memory 120 may be any nonvolatile memory that is managed using conversion between a logical address and a physical address. Such modification can also produce the same advantageous effects as the embodiment described above.

(2) The size and the number of logical blocks, the size and the number of physical blocks, and the number of partitions in the above embodiment are mere examples, and may be different from those exemplified in the above embodiment. Such modification can also produce the same advantageous effects as the embodiment described above.

(3) The type and arguments of commands received by the nonvolatile storage device 100 in the above embodiment are mere examples. For example, although the number of the partition PTn to which data is to be written is designated every time when the data writing process is performed in the above embodiment, the partition number may be designated only when the first data is written to the partition PTn. Such modification can also produce the same advantageous effects as the embodiment described above.

When the memory controller 110 includes a file system management unit that manages file system information generated in partitions of the data storage area 121, the relative logical address RLA within the partitions does not need to be designated. In this case, the file system management unit should calculate the relative logical address RLA based on, for example, a file name FN, an offset FO in a file, and a size SZ. Such modification can also produce the same advantageous effects as the embodiment described above.

(4) The memory controller 110 in the above embodiment is physically formed by a microcomputer (specifically a CPU), a ROM (read-only memory) storing programs that are executed by the microcomputer, a RAM (random-access memory) as a work space, a RAM forming the logical-to-physical conversion table 112, the physical block management table 113, and the partition management table 114, special hardware used to access the nonvolatile memory 120, and other modules. Such hardware that forms the memory controller 110 may be integrated on a single chip mounted on a nonvolatile storage device.

### INDUSTRIAL APPLICABILITY

The present technology is applicable to a large-capacity information storage medium used in a digital AV device, a mobile telephone unit, and an electronic device such as a personal computer. The present technology is particularly effective when applied to a semiconductor storage medium formed by a flash memory, which has been developed to have a larger capacity.

1. A memory controller that accesses a nonvolatile memory having a storage area whose logical address space is partitioned, the memory controller comprising:
a partition management table storing a number and a size of a partition that partitions the logical address space;
a logical-to-physical conversion table storing a correspondence between a logical address of the nonvolatile memory and a physical address of the nonvolatile memory;
a storage area management unit that externally receives a command indicating to change a partition, and changes a size of the partition stored in the partition management table and changes a correspondence between a logical address and a physical address stored in the logical-to-physical conversion table in accordance with size change performed for the partition; and
a memory interface that accesses the nonvolatile memory using a physical address that is obtained from the logical-to-physical conversion table by the storage area management unit.

2. The memory controller according to claim 1, wherein when the command indicates to increase the size of the partition, the storage area management unit updates the partition management table by changing the size of the partition to a designated size, and updates the logical-to-physical conversion table by changing an address of a physical block corresponding to a partition subsequent to the partition for which size change is performed in a manner to correspond to an address of a logical block greater by an amount of the size increase.

3. The memory controller according to claim 1, wherein when the command indicates to decrease the size of the partition, the storage area management unit updates the partition management table by changing the size of the partition to a designated size, and updates the logical-to-physical conversion table by changing an address of a physical block corresponding to a partition subsequent to the partition for which size change is performed in a manner to correspond to an address of a logical block smaller by an amount of the size decrease.

4. A nonvolatile storage device comprising:
a nonvolatile memory having a storage area whose logical address space is partitioned; and
a memory controller that accesses the nonvolatile memory,
wherein the memory controller includes
a partition management table storing a number and a size of a partition that partitions the logical address space,
a logical-to-physical conversion table storing a correspondence between a logical address of the nonvolatile memory and a physical address of the nonvolatile memory,
a storage area management unit that externally receives a command indicating to change a partition, and changes a size of the partition stored in the partition management table and changes a correspondence between a logical address and a physical address stored in the logical-to-physical conversion table in accordance with size change performed for the partition, and
a memory interface that accesses the nonvolatile memory using a physical address that is obtained from the logical-to-physical conversion table by the storage area management unit.

5. The nonvolatile storage device according to claim 4, wherein when the command indicates to increase the size of the partition, the storage area management unit updates the partition management table by changing the size of the partition to a designated size, and updates the logical-to-physical conversion table by changing an address of a physical block corresponding to a partition subsequent to the partition for which size change is performed in a manner to correspond to an address of a logical block greater by an amount of the size increase.

6. The nonvolatile storage device according to claim 4, wherein when the command indicates to decrease the size of the partition, the storage area management unit updates the partition management table by changing the size of the partition to a designated size, and updates the logical-to-physical conversion table by changing an address of a physical block corresponding to a partition subsequent to the partition for which size change is performed in a manner to correspond to an address of a logical block smaller by an amount of the size decrease.

7. A nonvolatile storage system comprising: a nonvolatile storage device; and an access device that accesses the nonvolatile storage device,
wherein the nonvolatile storage device includes a nonvolatile memory and a memory controller that accesses the nonvolatile memory, and
the memory controller includes a partition management table storing a number and a size of a partition that partitions the logical address space,
a logical-to-physical conversion table storing a correspondence between a logical address of the nonvolatile memory and a physical address of the nonvolatile memory,
a storage area management unit that externally receives a command indicating to change a partition, and changes a size of the partition stored in the partition management table and changes a correspondence between a logical address and a physical address stored in the logical-to-physical conversion table in accordance with size change performed for the partition, and
a memory interface that accesses the nonvolatile memory using a physical address that is obtained from the logical-to-physical conversion table by the storage area management unit.

8. The nonvolatile storage system according to claim 7, wherein when the command indicates to increase the size of the partition, the storage area management unit updates the partition management table by changing the size of the partition to a designated size, and updates the logical-to-physical conversion table by changing an address of a physical block corresponding to a partition subsequent to the partition for which size change is performed in a manner to correspond to an address of a logical block greater by an amount of the size increase.

9. The nonvolatile storage system according to claim 7, wherein when the command indicates to decrease the size of the partition, the storage area management unit updates the partition management table by changing the size of the partition to a designated size, and updates the logical-to-physical conversion table by changing an address of a physical block corresponding to a partition subsequent to the partition for which size change is performed in a manner to correspond to an address of a logical block smaller by an amount of the size decrease.
